(19) United States
(12) Patent Application Publication
(10) Pub. No.: US 2007/0006924 A1
(43) Pub. Date: Jan. 11, 2007

(54) Servo-controlled pneumatic pressure oscillator for respiratory impedance measurements and high-frequency ventilation

(76) Inventors: David W. Kaczka, Baltimore, MD (US); Kenneth R. Lutchen, Boston, MA (US)

Correspondence Address: Gauthier & Connors LLP, Suite 2300, 225 Franklin Street, Boston, MA, 02110, US

(21) Appl. No.: 11/471,181

(22) Filed: Jun. 20, 2006

Related U.S. Application Data
(63) Continuation of application No. PCT/US05/00134, filed on Jan. 4, 2005.
(60) Provisional application No. 60/534,306, filed on Jan. 5, 2004.

(51) Int. Cl. F16K 17/00

(52) U.S. Cl. 137/458

(57) ABSTRACT

A pneumatic ventilation system delivers high amplitude, low frequency oscillatory flows while maintaining the load impedance at a specified mean pressure, thereby accurately controlling mean airway pressure, oscillation amplitude, and frequency content allowing use in applications to optimize high frequency ventilation protocols in patients. The pneumatic ventilation system includes a pneumatic pressure oscillator based on a proportional solenoid valve to provide forced oscillatory excitations to a respiratory system over a bandwidth suitable for mechanical impedance measurements and high frequency ventilation.

### PRIORITY INFORMATION

The present patent application claims priority under 35 U.S.C. §119 from U.S. Provisional Patent Application Ser. No. 60/534,306 filed on Jan. 5, 2004. The entire contents of U.S. Provisional Patent Application Ser. No. 60/534,306 filed on Jan. 5, 2004 are hereby incorporated by reference.

### GOVERNMENT RIGHTS NOTICE

The present invention was made with Government Support under Grant Numbers R01 HL050515 and R01 HL062269 awarded by the National Institutes of Health and Grant Number BES-9309426 awarded by the National Science Foundation. The Government has certain rights in the present invention.

### FIELD OF THE PRESENT INVENTION

The present invention is directed to a device for measuring respiratory input impedance to assess the dynamic mechanical status of the lungs with also providing high frequency ventilation to the lungs. More particularly, the present invention is directed to a device for measuring the respiratory input impedance over low frequencies (0.1-10 Hz), which can provide an indication of serial and parallel airway heterogeneity within the lungs, the locus of airway constriction within the lungs, and/or the partitioning of the mechanical properties of airways within the lungs and lung tissues.

### BACKGROUND OF THE PRESENT INVENTION

The measurement of respiratory input impedance, the complex ratio of transrespiratory (or transpulmonary) pressure to flow at the airway opening as a function of frequency, can be used for assessing the dynamic mechanical status of the lungs. When measured over low frequencies (0.1-10 Hz), respiratory impedance can be a sensitive indicator of serial and parallel airway heterogeneity, provides insight into the locus of airway constriction, and may be useful in partitioning the mechanical properties of airways and lung tissues.

Several approaches have been developed to measure low frequency respiratory impedance in humans and large animals. One common approach is to excite the respiratory system with small amplitude pseudorandom noise using a loud-speaker. While straightforward, this technique has several technical and clinical drawbacks. It requires high-performance subwoofer speakers relatively free of harmonic distortion. Moreover, only non-physiologic flows can be generated (typically less than 0.2 L/s) that are often load-dependent unless a closed-loop design is employed. Finally, this approach requires considerable subject cooperation.

Other approaches have incorporated high amplitude broadband flow forcings into waveforms that mimic physiological breathing maneuvers. Specifically, Optimal Ventilator Waveforms and Enhanced Ventilator Waveforms concentrate flow spectral energy at specific frequencies to minimize nonlinear harmonic distortion in the resulting pressure waveforms. The phases of these waveforms are optimized to achieve tidal volume excursions sufficient for gas exchange, and thus are more clinically appropriate for awake and anesthetized patients. Presently, these waveforms must be generated by piston-cylinder arrangements actuated by servo-controlled linear motors, allowing for delivery of high amplitude and load-independent oscillatory flows. Despite the ability of such systems to produce high fidelity flow waveforms, they can be extremely inefficient due to mechanical friction and stick-slip effects between the piston and cylinder.

Another approach is disclosed in U.S. Pat. No. 5,555,880 to Winter et al. U.S. Pat. No. 5,555,880 discloses a high frequency oscillatory ventilator using feedback control to maintain either the desired tidal volume or pressure delivered to the subject. The ventilator uses feedback control of the exhaust flow to maintain mean airway pressure. The oscillations are provided only during positive pressure situations. The input impedance of the endotracheal tube is measured and continuously monitored tube so that the ventilator can maintain either the tidal volume or pressure delivered to the patient.

A further approach is disclosed in U.S. Pat. No. 6,131,571 to Lampotang et al. U.S. Pat. No. 6,131,571 discloses a ventilation apparatus that utilizes a proportional flow control valve, in response to signals from pressure or flow sensors that are positioned to provide measurements representative of the actual pressure and flow conditions within the patient's lungs, controls the flow rate during inspiration. It is further disclosed that readings of the pressure within the lungs provide data to enable to the governance of the operation of proportional flow control valve during ventilation.

U.S. Pat. No. 6,257,234 to Sun discloses a ventilator that is controlled by detecting the resistance or elastance of the patient's respiratory system and adjusting the flow supplied by the ventilator accordingly. By controlling the ventilator to superimpose at least one forced single oscillation on the flow and observing the reaction of the respiratory system, the device detects the resistance. The elastance is detected by controlling the ventilator to supply a pressure which has the effect of temporarily occluding the respiratory system, waiting until the respiratory system has reached equilibrium, and observing the resulting state of the respiratory system.

Regardless of the method employed to acquire respiratory impedance data, a more vexing problem is the ability to make oscillatory measurements while the lungs are maintained at a specified mean volume or pressure. Since lung volume can significantly impact respiratory impedance, the ability to provide forced oscillations at different lung volumes or mean airway pressures is useful in understanding the impact of positive end-expiratory pressure, periodic sighs, and recruitment/derecruitment maneuvers on dynamic lung mechanics.

In addition to the diagnostic information that forced oscillations provide, such excitations can be therapeutic as well. High frequency ventilation is becoming a standard of care in neonatal lung injury, and there has been renewed interest in using this ventilatory modality in the treatment of pediatric and adult lung injury as well. In contrast to conventional mechanical ventilation, high frequency ventilation maintains gas exchange using small tidal volumes (often less than anatomic dead space) delivered at supraphysiologic rates (i.e., 5 to 15 Hz). However, the use of high frequency ventilation in clinical environments requires fine control over both the mean level of airway pressure as well as the amplitude of peak-to-peak pressure oscillations.

Therefore, it is desirable to provide a ventilation device that measures the impedance of the lungs while providing high frequency ventilation. Moreover, it is desirable to provide a ventilation device that delivers high amplitude flow with a dynamic response suitable for both impedance measurements and high frequency ventilation; provides fine control over the amplitude of the peak-to-peak pressure oscillations; and/or generates pressure oscillations under both positive and negative load pressures and delivers bi-directional broadband oscillatory flows.

### SUMMARY OF THE PRESENT INVENTION

A first aspect of the present invention is a pneumatic pressure system. The pneumatic pressure system includes a proportional solenoid valve to provide high frequency ventilation to an impedance load connected to the proportional solenoid valve; a pressure sensor to measure a pneumatic pressure of the impedance load; and a control unit, operatively connected to the proportional solenoid valve and the pressure sensor, to compare the measured pneumatic pressure of the impedance load with a desired mean pressure and produces a pressure control signal corresponding to the comparison of the measured pneumatic pressure of the impedance load with the desired mean pressure. The proportional solenoid valve adjusts a pneumatic flow therethrough in response to the produced pressure control signal.

A further aspect of the present invention is a pneumatic pressure system. The pneumatic pressure system includes a proportional solenoid valve to provide high frequency ventilation to an impedance load connected to the proportional solenoid valve; a pressure sensor to measure a pneumatic pressure of the impedance load; and a control unit, operatively connected to the proportional solenoid valve and the pressure sensor, to compare the measured pneumatic pressure of the impedance load with a desired oscillatory pressure and produces a control signal corresponding to the comparison of the measured pneumatic pressure of the impedance load with the desired oscillatory pressure. The proportional solenoid valve adjusts a pneumatic flow therethrough in response to the produced control signal.

A further aspect of the present invention is a method for providing pneumatic pressure. The method provides high frequency ventilation, using a proportional solenoid valve, to an impedance load; measures a pneumatic pressure of the impedance load; compares the measured pneumatic pressure of the impedance load with a desired mean pressure; produces a pressure control signal corresponding to the comparison of the measured pneumatic pressure of the impedance load with the desired mean pressure; and adjusts a pneumatic flow through the proportional solenoid valve in response to the produced pressure control signal.

A further aspect of the present invention is a method for providing pneumatic pressure. The method provides high frequency ventilation, using a proportional solenoid valve, to an impedance load; measures a pneumatic pressure of the impedance load; compares the measured pneumatic pressure of the impedance load with a desired oscillatory pressure; produces a pressure control signal corresponding to the comparison of the measured pneumatic pressure of the impedance load with the desired oscillatory pressure; and adjusts a pneumatic flow through the proportional solenoid valve in response to the produced pressure control signal.

### BRIEF DESCRIPTION OF THE DRAWINGS

The present invention may take form in various components and arrangements of components, and in various steps and arrangements of steps. The drawings are only for purposes of illustrating a preferred embodiment and are not to be construed as limiting the present invention, wherein:

FIG. 1 illustrates a schematic of a pneumatic pressure oscillator according to the concepts of the present invention;

FIG. 2 illustrates a block diagram of a pneumatic pressure oscillator according to the concepts of the present invention;

FIG. 3 illustrates a schematic diagram of electronics of a servo-control circuit for a pneumatic pressure oscillator according to the concepts of the present invention;

FIG. 4 graphically shows steady-state voltage-flow curves for increasing and decreasing control voltages corresponding to an electronic control unit proportional solenoid valve combination;

FIG. 5 graphically shows magnitude and phase responses corresponding to an open-loop electronic control unit proportional solenoid valve combination;

FIG. 6 graphically shows input control voltage and output flow harmonic distortion indices corresponding to an electronic control unit proportional solenoid valve combination;

FIG. 7 graphically shows magnitude and phase responses for a closed-loop pressure oscillator according to the concepts of the present invention;

FIG. 8 graphically shows input control voltage and output pressure harmonic distortion indices for a pneumatic pressure oscillator according to the concepts of the present invention;

FIGS. 9 and 10 graphically show actual pressure tracings for the resistor and glass bottle mechanical load;

FIG. 11 graphically shows mechanical test load resistance and elastance versus frequency at mean load pressures; and

FIG. 12 graphically shows simulated magnitude and phase response for the closed-loop pressure oscillator according to the concepts of the present invention.

### DETAIL DESCRIPTION OF THE PRESENT INVENTION

The present invention will be described in connection with preferred embodiments; however, it will be understood that there is no intent to limit the present invention to the embodiments described herein. On the contrary, the intent is to cover all alternatives, modifications, and equivalents as may be included within the spirit and scope of the present invention, as defined by the appended claims.

For a general understanding of the present invention, reference is made to the drawings. In the drawings, like reference have been used throughout to designate identical or equivalent elements. It is also noted that the various drawings illustrating the resent invention are not drawn to scale and that certain regions have been purposely drawn disproportionately so that the features and concepts of the present invention could be properly illustrated.

As noted above, it is desirable to make oscillatory measurements while the lungs are maintained at a specified mean volume or pressure. Since lung volume can significantly impact respiratory impedance, the ability to provide forced oscillations at different lung volumes or mean airway pressures is useful in understanding the impact of positive end-expiratory pressure, periodic sighs, and recruitment/derecruitment maneuvers on dynamic lung mechanics. In addition to the diagnostic information that forced oscillations provide, such excitations can be therapeutic as well. For example, high frequency ventilation maintains gas exchange using small tidal volumes (often less than anatomic dead space) delivered at supraphysiologic rates (i.e., 5 to 15 Hz).

As noted above, forced oscillation technique has evolved into a powerful tool for the assessment of respiratory mechanics. It has the potential for routine use in pulmonary medicine for both diagnostic and therapeutic purposes. Respiratory impedance can provide much information about the mechanical status of the lungs, and high frequency ventilation is becoming a popular ventilatory modality, especially in patients with the Acute. Respiratory Distress Syndrome.

Since Acute Respiratory Distress Syndrome is a mechanically heterogenous disease, it can be a challenge to maintain the delicate balance between oxygenation and overdistention injuries. While conventional mechanical ventilation may predispose certain regions of the lung to further injury with high tidal volumes and sub-optimal-end-expiratory pressures, high frequency ventilation can maintain gas exchange at specified mean alveolar volumes while minimizing the impact of cyclic overdistention and shear stresses associated with intra-tidal derecruitment of lung volume.

The present invention provides a pneumatic pressure oscillator capable of delivering physiological flows and tidal volumes over a frequency range sufficient for impedance measurements and high frequency ventilation. More specifically, the present invention provides a pneumatic pressure oscillator that is capable of high amplitude flow delivery (>1.4 L/s) with a dynamic response suitable for low frequency respiratory impedance measurements as well as high frequency ventilation; utilizes a servo-control mechanism to maintain the respiratory system at a specified mean pressure during oscillatory excitation; and minimizes electrical power consumption compared to traditional linear motor driven devices used for the same purposes.

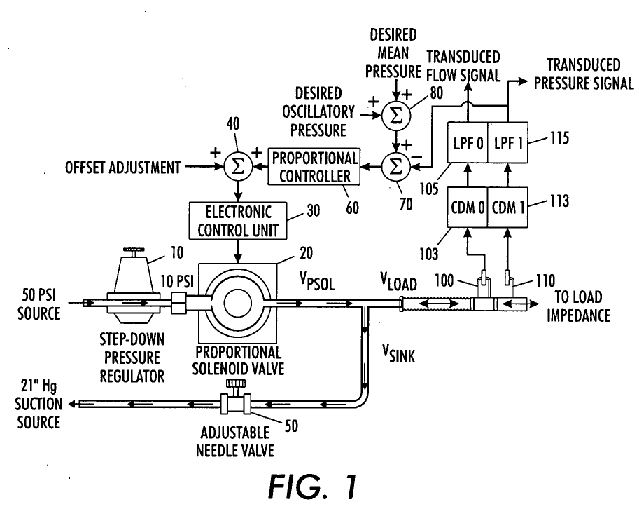

A pneumatic pressure oscillator, according to the concepts of the present invention, is schematically depicted in FIG. 1. The pneumatic pressure oscillator includes a proportional solenoid valve 20, preferably an ASCO Posiflow™ Model SD8202G4V, Florham Park, N.J. Flow through the proportional solenoid valve 20 is determined by the position of a spring-loaded core. An electronic control unit 30 produces an electric current which is applied to a solenoid coil within the proportional solenoid valve 20. This electric current generates an electromagnetic pullforce on the core, thereby controlling the flow through the proportional solenoid valve 20. When this pullforce exceeds the opposing spring force, the core moves upward and opens the valve. The degree to which the valve opens is proportional to the current applied to the coil.

As noted above, accurate positioning of the core within the proportional solenoid valve 20 is provided by the electronic control unit 30. In a preferred embodiment, the electronic control unit 30 may convert a 0-10 volt control signal to a 24 V pulse-width modulated coil-excitation signal. In this embodiment, the average current through the coil and the amplitude of the current variations may be dependent on the switching frequency of the pulse-width modulation. The electronic control unit 30 may provide additional control of the current to compensate for any temperature-dependent changes in coil resistance.

The pneumatic pressure oscillator also includes a pressure regulator 10 to step down the pressure before it is introduced into the proportional solenoid valve 20. In a preferred embodiment, the pressure received by the pressure regulator 10 may be 50 psi wall source pressure wherein the pressure regulator 10 may step down this pressure to 10 psi before it is introduced into the proportional solenoid valve 20.

The pneumatic pressure oscillator includes a suction line with an adjustable needle valve 50 to achieve bidirectional flows. The suction line with an adjustable needle valve 50 is connected immediately after an output nozzle of the proportional solenoid valve 20. In a preferred embodiment, the suction line with an adjustable needle valve 50 may provide a suction source of 21″ Hg. The high input impedance of suction line minimizes the shunting of oscillatory flows through it. By matching the steady flow though this sink (Vₛᵢₙₖ) to the mean flow coming directly from the proportional solenoid valve 20 (Vₚₛₒₗ), the resulting flow delivered to the load impedance (V_{load}) becomes purely oscillatory or bidirectional.

The pneumatic pressure oscillator includes further includes a flow sensor 100 and a pressure sensor 110 which produces electrical signals. The electrical signals are transduced, respectively, by circuits 103 and 113. The transduced signals are low pass filtered, respectively, by filters 105 and 115. The filtered pressure signal is fed to a summing circuit 70 which sums the measured pressure signal with a signal from summing circuit 80. Summing circuit 80 sums a desired oscillatory pressure signal with a desired mean pressure signal.

The signal from summing circuit 70 is fed to a proportional controller 60 that converts the signal to a control voltage that can be readily utilized by the electronic control unit 30 to control the flow through proportional solenoid valve 20. The signal from proportional controller 60 may be further modified by an offset adjustment voltage through summing circuit 40.

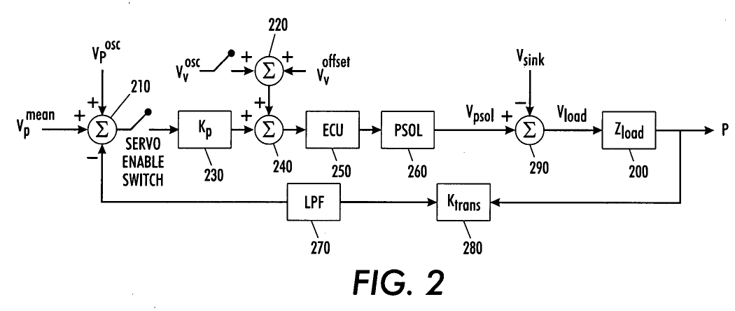

A block diagram of the pneumatic pressure oscillator, as explemified by the concepts of the present invention, is illustrated in FIG. 2. Control voltages, corresponding to the desired mean pressure (vₚ^{mean}) and desired oscillatory pressure (vₚ^{osc}), as set by an operator, are fed to comparator 210. The actual load pressure (P) is electrically transduced (Kₜᵣₐₙₛ) by circuit 280, low-pass filtered (LPF) by filter 270, and compared to the total desired pressure signal by comparator 210. Since the frequency response of the entire closed-loop system depends on the mechanical load impedance 200 (Z_{load}) under excitation, a proportional controller 230 (Kₚ) is added to adjust the amplitude of the error signal before it was presented to the electronic control unit 250 (ECU). The electronic control unit 250 (ECU) provides the appropriate control signals to the proportional solenoid valve 260. The flow from the proportional solenoid valve 260 is combined with a vacuum pressure at junction 290.

Alternatively, a direct open-loop excitation of the pneumatic pressure oscillator system is possible with the servo enable switch 215 opened. Here, the user may apply control voltages corresponding to an offset adjustment (uᵥ^{offset}) or an oscillatory flow component (uᵥ^{osc}) through summing circuits 220 and 240. Such an open-loop arrangement may be useful when precise control of mean load pressure is not needed, as when measuring the impedance of a cylinder or pipe opened to the atmosphere. An open-loop configuration may also be desirable if an expiratory valve system is incorporated into the device to allow a patient-driven exhalation to the atmosphere or against positive end-expiratory pressure. Such an open-loop system is described in U.S. Pat. No. 6,435,182. The entire content of U.S. Pat. No. 6,435,182 is hereby incorporated by reference. In this situation, direct excitation of the valve occurs during inspiration. Mean airway pressure will not be servo-controlled and will instead be a function of both peak and end-expiratory pressures as well as breathing frequency.

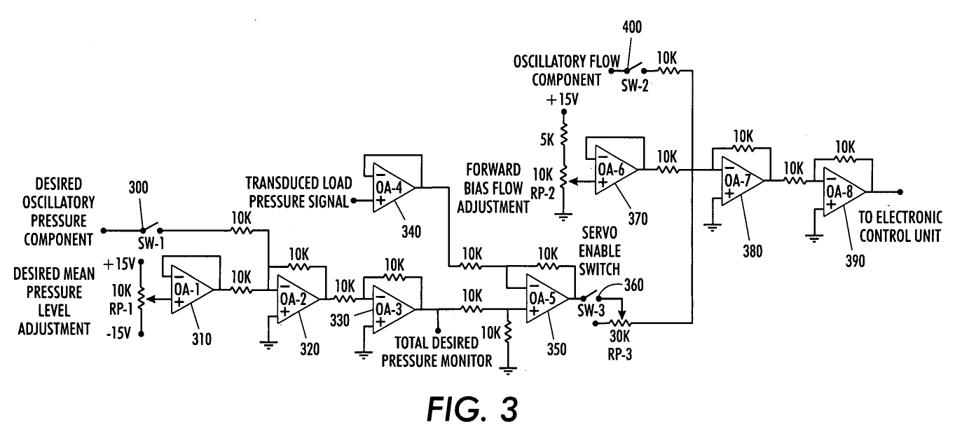

FIG. 3 illustrates the electronics schematic for the servo-control circuit of the pneumatic pressure oscillator system, according to the concepts of the present invention. A user may adjust the voltage corresponding to the desired mean pressure level with potentiometer RP-1. This signal is then buffered by op-amp 310 and summed by op-amp 320 with a voltage corresponding to the desired oscillatory pressure component as applied through switch 300. The total desired pressure signal is then inverted by op-amp 330.

This signal is then compared at op-amp 350 to the actual transduced pressure signal buffered by op-amp 340. Potentiometer RP-3 adjusts the gain of the proportional controller. The amplified error signal is then added at op-amp 380 to a 0-10 V offset DC-voltage (vᵥ^{offset}), which is adjusted at RP-2 and buffered by op-amp 370 to ensure that the proportional solenoid valve is operating about is linear region. An additional summing junction is available at switch 400 for direct external excitation of the pneumatic pressure oscillator system. A servo enable switch 360 may be thrown when closed-loop control of the load pressure is desired. The entire actuating signal is then inverted at op-amp 390 before being passed on to the electronic control unit.

The steady-state linearity of the proportional solenoid valve was assessed first by presenting a DC voltage to the electronic control unit and measuring the corresponding flow output from the solenoid using a calibrated pneumotachograph connected to a 0-2 cm H₂O variable reluctance pressure transducer. Input voltage was first increased in 0.1 to 0.4 volt increments up to 12 volts, and then decreased back down to 0 volts in a similar fashion. Control voltages to the electronic control unit were measured by a digital multi-meter. Hysteresis of the system was determined as the maximum difference in flow over this single calibration cycle expressed as a percent of the full-scale flow.

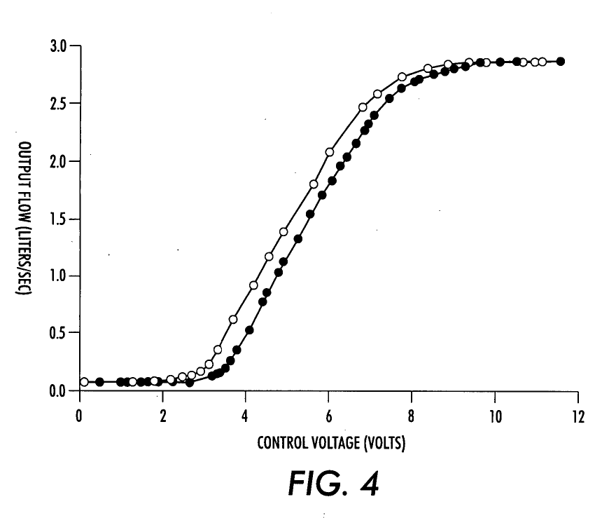

To evaluate the load-free performance of the proportional solenoid valve in terms of the quality of its generated flow waveforms, its open-loop dynamic response was determined using a pseudorandom signal consisting of 15 sinusoids with equivalent amplitudes and random phases. The frequency components were chosen to obey the non-sum non-difference (NSND) criteria of Suki and Lutchen such that the impact of harmonic distortion and cross talk in the system output would be minimized. A 2048-point NSND waveform with energy concentrated between 0.098 to 40.97 Hz was generated with a digital-to-analog converter at a shift frequency of 100 Hz. The output of the D/A converter was low pass filtered at 50 Hz and electronically summed with a 5-volt DC component (op-amp 360 in FIG. 3) to ensure operation of the proportional solenoid valve about its mid-range to minimize the effects of saturation nonlinearities. The results of this evaluation are illustrated in FIG. 4.

The steady-state voltage-flow curves for both increasing and decreasing control voltages are shown in FIG. 4. Both limbs were sigmoidal in nature, but were fairly linear over the 3 to 8 volt range, corresponding to minimum and maximum flows of approximately 0.2 to 2.5 L/s, respectively. The proportional solenoid valve exhibited approximately 7% hysteresis over the full range of flows from 0 to 2.85 L/s.

The output nozzle of the proportional solenoid valve was opened to atmosphere, and flow was measured using the same pneumotach arrangement described above. Both the input voltage and output flow signals were low pass filtered at 50 Hz, sampled at 100 Hz with an analog-to-digital converter. The amplitude of the D/A output was adjusted to achieve peak NSND voltages of 0.4, 0.8, 1.2, 1.6 and 2.0 volts, which were presented to the electronic control unit in random order. The open-loop transfer function of the system was determined from the ratio of the cross power spectrum of the input voltage and output flow to the autopower spectrum of voltage. After neglecting the first three transient NSND cycles, six 20.48 second rectangular windows with 83% overlap were used to calculate the transfer function, which was expressed in polar coordinates. Measurements were made with and without the suction in-line to determine the impact of suction on the dynamics and linearity on the output flow.

To quantify dynamic nonlinear harmonic distortion and cross-talk of the open-loop system, an harmonic distortion index (k_{d}) appropriate for broad-band excitations was used:
k_{d}=100%×(P_{NI}/P_{TOT})^{1/2}
where P_{TOT} is the total power in the signal (i.e., sum of squared magnitudes in the frequency-domain) and P_{NI} is the power at noninput (i.e., non-NSND) frequencies. To determine the impact of nonlinearities and noise present at non-NSND frequencies in the analogue input driving signal, k_{d} was calculated for both the input voltage and output flow waveforms.

The closed-loop performance of the system was assessed using a simulated mechanical load impedance consisting of a screen-mesh resistor in series with a 20 L glass bottle packed with copper wool to minimize the temperature changes associated with cyclic gas compression The resistive load (R_{load}) of the screen-mesh was experimentally determined to be approximately 4 cm H₂O/L/s. The elastic load (E_{load}) provided by the bottle was determined from Boyle's Law:

$${E}_{load} = β \frac{{P}_{0}}{{V}_{0}}$$

where P₀ represents the absolute mean bottle pressure (approximately 1033 cm H₂O for 1 atm), V₀ represents the compressible volume of the chamber (20 L in our case), and β is a constant equal to 1.0 for isothermal compression and 1.4 for adiabatic compression. Assuming a mean bottle pressure of zero relative to atmosphere, the theoretical elastic loads of the bottle was computed as 51.68 and 72.35 cm H₂O/L for isothermal and adiabatic compression, respectively. The input-driving signal to the system was identical to the NSND waveform described above.

Peak oscillatory NSND control voltage amplitudes were adjusted to 1, 2, 3, 4, and 5 volts and applied in random order. The mean load pressure was maintained at 0 cm H₂O. A 0-50 cm H₂O pressure transducer was located proximal to the screen resistor for measurement and feedback of the load pressure. The proportional controller gain Kₚ was set to approximately 0.3 by adjusting the RP-3 potentiometer of FIG. 3. Both the desired and actual pressure signals were sampled and processed as described previously. The closed-loop transfer function of the system was computed using the cross-power spectral method with the actual load pressure as the system output. The k_{d} indices were also computed for the input control voltage and output load pressure.

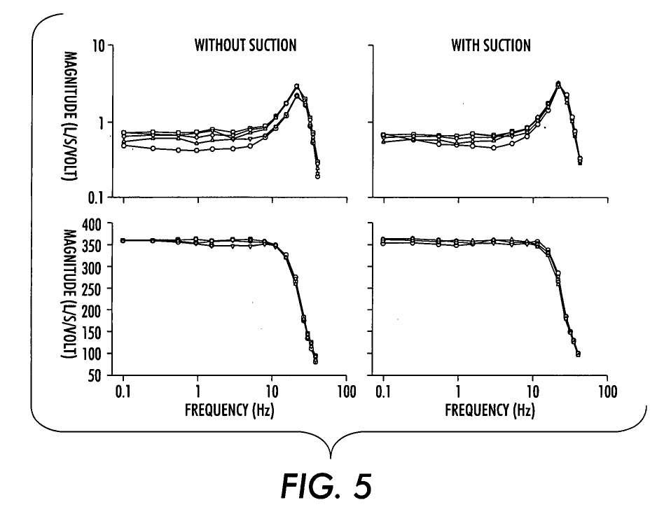

FIG. 5 shows the magnitude and phase response of the open-loop system for NSND peak amplitudes of 0.4, 0.8, 1.2, 1.6, and 2.0 volts, corresponding to peak-to-peak output flows of 0.76, 1.68, 2.50, 2.83, and 2.99 L/s, respectively. Measurements were made with and without suction. In both cases, the magnitude and phase responses are relatively flat out to 10 Hz. For all amplitudes, the system consistently demonstrated a resonance at about 21 Hz. While the magnitude response did demonstrate some variability below 10 Hz with amplitude, there was no consistent trend with increasing amplitude. The phase response demonstrated minimal variability regardless of NSND amplitude. Suction reduced much of the variability observed in the magnitude below 10 Hz, but appeared to have little impact on the open-loop phase response of the proportional solenoid valve.

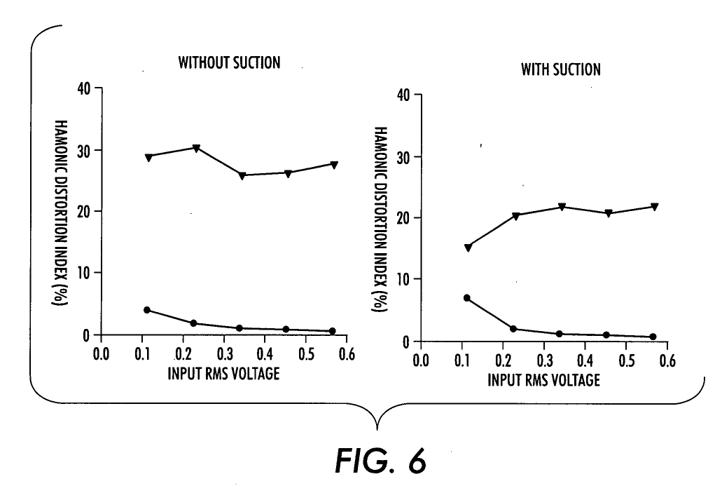

FIG. 6 shows the input voltage and output flow harmonic distortion indices as a function of input RMS voltage with and without suction. In both cases, k_{d} for the input control voltage was minimal, demonstrating an RMS-dependent decrease below 0.2 volts RMS, above which it became fairly constant and less than 2%. The k_{d} for flow was substantially higher. With no suction applied, it averaged 28.05% with a standard deviation of 1.81%. When suction was applied however, the flow k_{d} dropped significantly, averaging 19.90% with a standard deviation of 3.03%, and exhibited a slight trend of increasing harmonic distortion with increasing RMS voltage.

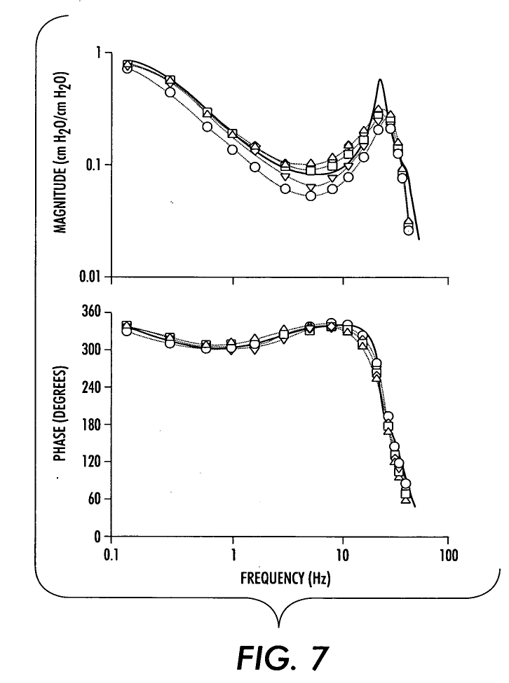

FIG. 7 shows the magnitude and phase plots for the closed-loop pressure oscillator from 0.098 to 40.97 Hz with peak NSND voltages of 1, 2, 3, 4, and 5 volts, corresponding to peak-to-peak pressures of 4.0, 9.9, 16.2, 21.2, and 24.9 cm H₂O. Measurements were made with the mechanical load at a mean pressure of 0 cm H₂O relative to atmosphere. In all cases, the magnitude reaches a minimum at about 5 Hz, and thereafter increases to a maximum at about 21 Hz. The phase response demonstrated slight negative frequency dependence out to 1 Hz. Beyond 1 Hz, the phase gradually increased until about 11 Hz, thereafter demonstrating a sharp frequency-dependent drop. There was a slight positive dependence of the closed-loop magnitude with increasing NSND amplitude, although this was not seen in the phase response.

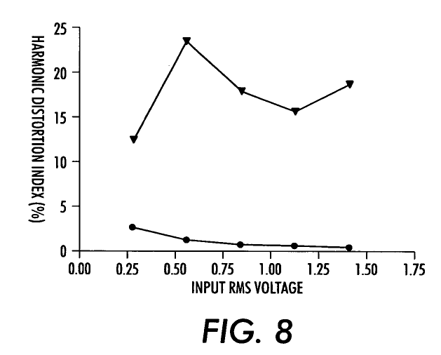

FIG. 8 shows the input voltage and output load pressure harmonic distortion indices. As seen previously for the open loop experiments, the k_{d} for the input driving voltage was minimal, and again exhibited a negative dependence on RMS voltage. The k_{d} for the load pressure, however, ranged from 12.56 to 23.54%, with no clear dependence on RMS voltage.

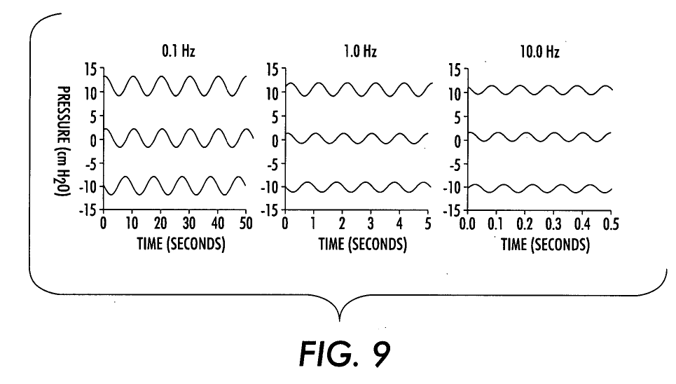

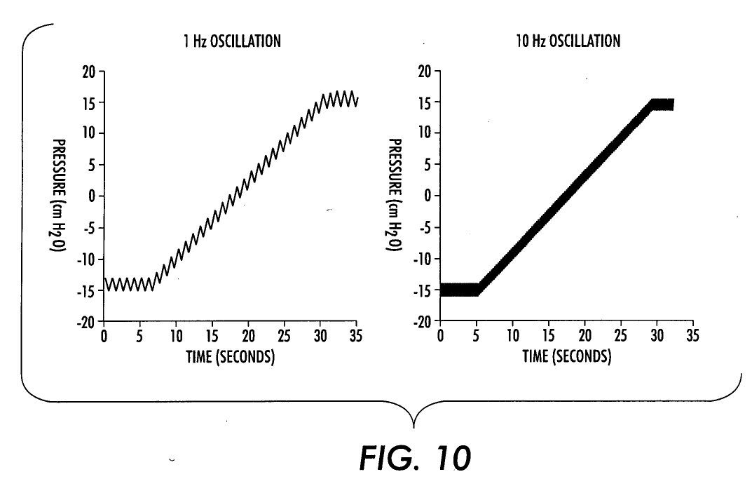

Examples of the actual pressure tracings for the mechanical test load at three frequencies (0.1, 1.0, and 10.0 Hz) and three mean pressures (−10, 0, and +10 cm H₂O) are shown in FIG. 9. Consistent with the closed-loop bode plot of FIG. 7, the actual peak-to-peak amplitude of the pressure oscillations decreased with increasing frequency. However, the servo system was able to maintain the mean pressure at a constant level in all cases. The ability of the closed-loop system to follow dynamic changes in the desired mean load pressure with superimposed 1 and 10 Hz oscillations is shown in FIG. 10.

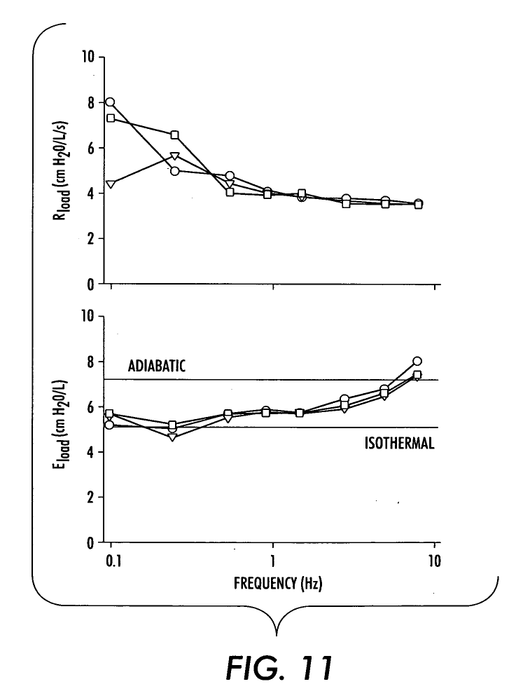

FIG. 11 shows the measured resistive and elastic components of the mechanical test load from approximately 0.09 to 8 Hz at mean pressures of −10, 0 and +10 cm H₂O. Also shown are the theoretical upper and lower limits for elastance, assuming isothermal gas compression at −10 cm H₂O and adiabatic gas compression at +10 cm H₂O, respectively. At all three mean load pressures, R_{load} shows a frequency-dependent decrease which asymptomically approaches a value approximately equal to the screen resistance of 4 cm H₂O /L/s. Except at the very highest frequency, E_{load} was within its theoretical upper and lower limits, with all three curves demonstrating a trend of a increasing from isothermal to adiabatic compression as frequency increased.

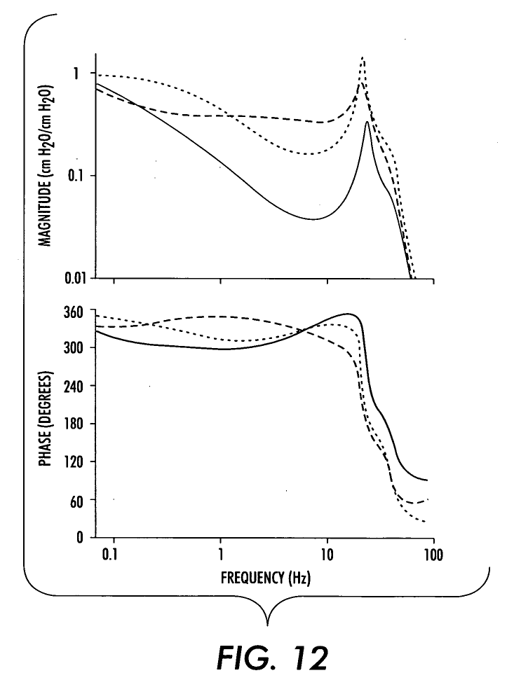

FIG. 12 shows the predicted magnitude and phase response of the closed-loop system with Z_{load} adjusted to correspond to healthy adult, pediatric, and Chronic Obstructive Pulmonary Disease conditions. While the magnitude demonstrated a significant roll-off from 0.1 to 10.0 Hz for both healthy adult and pediatric conditions, the predicted magnitude response for Chronic Obstructive Pulmonary Disease patients was considerably flatter over this bandwidth, implying an improved frequency response of the system for these patients. Accordingly, the mechanical status of a patient's respiratory system will have significant influence on the dynamic behavior of this device. To compensate for this, the analog proportional controller gain Kₚ may be adjusted and the system performance fine-tuned from subject to subject. Alternatively, a PID controller could easily be incorporated into the device to further improve the system's frequency response. Since the pressure in the load is continuously sampled by an A/D board, a digital feedback controller could also be implemented and various discrete and/or adaptive controllers could be readily programmed to achieve any desired system dynamic requirements.

As demonstrated above, the present invention is capable of delivering broadband, high amplitude oscillatory flows while maintaining a mechanical test load at a constant mean pressure. Moreover, the present invention has the ability to generate pressure oscillations under both positive and negative load pressures (FIGS. 9 and 10). This may be useful in applications involving negative pressure ventilation or control of pleural pressure. Also, the present invention has the ability to follow dynamic changes in desired mean airway pressure during sinusoidal oscillations (FIG. 10) making it ideally suited for protocols involving the tracking effective airway caliber at different lung volumes. Finally, combining an exhalation valve system with the present invention allows the present invention to be used in a variety of different conventional ventilatory modalities, such as assist-control, SIMV, pressure control, or proportional assist ventilation.

The present invention, as discussed above, incorporates the load impedance into the servo-loop. As such, the frequency response of the closed loop system will depend on the mechanical properties of the load impedance, which will vary from patient to patient.

In summary, the present invention is capable of delivering high amplitude, low frequency oscillatory flows while maintaining the load impedance at a specified mean pressure. The present invention can be used for both low frequency respiratory mechanical impedance measurements as well as high frequency ventilation. Moreover, the present invention could be used to measure the oscillatory flow response or impedance in many other systems, such as pipes, hollowed chambers, or other biological organs. The present invention's ability to accurately control mean airway pressure, oscillation amplitude, and frequency content allows the present invention to be used in applications to optimize high frequency ventilation protocols in patients. Future implementations of the present invention may incorporate PID or adaptive control to achieve a desired frequency response or response time.

While various examples and embodiments of the present invention have been shown and described, it will be appreciated by those skilled in the art that the spirit and scope of the present invention are not limited to the specific description and drawings herein, but extend to various modifications and changes.

What is claimed is:

1. A pneumatic pressure system comprising:
a proportional solenoid valve to provide high frequency ventilation to an impedance load connected to said proportional solenoid valve;
a pressure sensor to measure a pneumatic pressure of the impedance load; and
a control unit, operatively connected to said proportional solenoid valve and said pressure sensor, to compare the measured pneumatic pressure of the impedance load with a desired mean pressure and producing a pressure control signal corresponding to the comparison of the measured pneumatic pressure of the impedance load with the desired mean pressure;
said proportional solenoid valve adjusting a pneumatic flow therethrough in response to the produced pressure control signal.

2. The pneumatic pressure system as claimed in claim 1, wherein said control unit includes an offset adjustment circuit to modify the pressure control signal by an offset value.

3. The pneumatic pressure system as claimed in claim 1, wherein said control unit includes an oscillatory flow component adjustment circuit to modify the pressure control signal by an oscillatory flow component value.

4. The pneumatic pressure system as claimed in claim 1, wherein said control unit includes an adjustment circuit to modify the pressure control signal by an offset value and an oscillatory flow component value.

5. The pneumatic pressure system as claimed in claim 1, further comprising an adjustable vacuum source connected between said pressure sensor and said proportional solenoid valve.

6. A pneumatic pressure system comprising:
a proportional solenoid valve to provide high frequency ventilation to an impedance load connected to said proportional solenoid valve;
a pressure sensor to measure a pneumatic pressure of the impedance load; and
a control unit, operatively connected to said proportional solenoid valve and said pressure sensor, to compare the measured pneumatic pressure of the impedance load with a desired oscillatory pressure and producing a control signal corresponding to the comparison of the measured pneumatic pressure of the impedance load with the desired oscillatory pressure;
said proportional solenoid valve adjusting a pneumatic flow therethrough in response to the produced control signal.

7. The pneumatic pressure system as claimed in claim 6, wherein said control unit includes an offset adjustment circuit to modify the pressure control signal by an offset value.

8. The pneumatic pressure system as claimed in claim 6, wherein said control unit includes an oscillatory flow component adjustment circuit to modify the pressure control signal by an oscillatory flow component value.

9. The pneumatic pressure system as claimed in claim 6, wherein said control unit includes an adjustment circuit to modify the pressure control signal by an offset value and an oscillatory flow component value.

10. The pneumatic pressure system as claimed in claim 6, further comprising an adjustable vacuum source connected between said pressure sensor and said proportional solenoid valve.

11. A method for providing pneumatic pressure, comprising:
(a) providing high frequency ventilation, using a proportional solenoid valve, to an impedance load;
(b) measuring a pneumatic pressure of the impedance load;
(c) comparing the measured pneumatic pressure of the impedance load with a desired mean pressure;
(d) producing a pressure control signal corresponding to the comparison of the measured pneumatic pressure of the impedance load with the desired mean pressure; and
(e) adjusting a pneumatic flow through the proportional solenoid valve in response to the produced pressure control signal.

12. The method as claimed in claim 11, further comprising:
(e) modifying the pressure control signal by an offset value.

13. The method as claimed in claim 11, further comprising:
(e) modifying the pressure control signal by an oscillatory flow component value.

14. The method as claimed in claim 11, further comprising:
(e) modifying the pressure control signal by an offset value and an oscillatory flow component value.

15. The method as claimed in claim 11, further comprising:
(e) providing an adjustable vacuum source between the impedance load and the proportional solenoid valve.

16. A method for providing pneumatic pressure, comprising:
(a) providing high frequency ventilation, using a proportional solenoid valve, to an impedance load;
(b) measuring a pneumatic pressure of the impedance load;
(c) comparing the measured pneumatic pressure of the impedance load with a desired oscillatory pressure;
(d) producing a pressure control signal corresponding to the comparison of the measured pneumatic pressure of the impedance load with the desired oscillatory pressure; and
(e) adjusting a pneumatic flow through the proportional solenoid valve in response to the produced pressure control signal.

17. The method as claimed in claim 16, further comprising:
(e) modifying the pressure control signal by an offset value.

18. The method as claimed in claim 16, further comprising:
(e) modifying the pressure control signal by an oscillatory flow component value.

19. The method as claimed in claim 16, further comprising:
(e) modifying the pressure control signal by an offset value and an oscillatory flow component value.

20. The method as claimed in claim 16, further comprising:
(e) providing an adjustable vacuum source between the impedance load and the proportional solenoid valve.
